(19) United States
(12) Patent Application Publication
(10) Pub. No.: US 2005/0244000 A1
(43) Pub. Date: Nov. 3, 2005

(54) Fast-key generator for encryption, authentication or security

(76) Inventor: Ryon K. Coleman, Gaithersburg, MD (US)

Correspondence Address: LAWRENCE HARBIN;MCINTYRE HARBIN & KING LLP, 500 9TH STREET, S.E., WASHINGTON, DC, 20003, US

(21) Appl. No.: 10/833,047

(22) Filed: Apr. 28, 2004

(51) Int. Cl. H04K 1/00

(52) U.S. Cl. 380/44

(57) ABSTRACT

A key generator that instantaneously generates an encryption/decryption key to provide a roaming device with secure and seamless access to various access points of a wireless network without interruption. The key generator comprises a multi-byte identifier shared by devices communicating with the network, a hashing module to transform the multi-byte identifier to a multi-bit digest thereof, a clock register that enables an output of a number of clock cycles determined by the digest, a programmable shift register that responds to the clock cycles to transform at least two safeguarded parameters to an output, and a spreader responsive to the digest and the output of the shift register to produce an encryption/decryption key.

### BACKGROUND

The present invention relates to information security, but more specifically to a method and an apparatus to generate keys to encrypt or decrypt data conveyed by devices in a secure network.

When establishing a secure session over a network, communicating devices typically undergo a series of authentication and encryption protocols to generate and exchange keys prior to transferring information. These protocols require a finite amount of time, which, in a wireless environment, introduce delays and/or interruptions in data flow. Delay become more pronounced and objectionable in a roaming environment when users move between and among wireless access points.

Wireless network devices currently employ data communication protocols such as IEEE 802.15.4/Zigbee, IEEE 802.15.1/Bluetooth, and 802.11 (especially 802.11i “Enhanced Security”) in which the devices rely on exchange of keys typically ranging in length from 64 bits to 256 bits to uniquely configure embedded encryption and/or authentication engines. IEEE 802.11i and other protocols, for example, specify methods for producing a PMK (pairwise master key) or a PTK (pairwise temporal key), which are derived from a root key.

Currently, there is a critical gap in the art to rapidly and dynamically generate encryption keys for use by roaming or other network devices, such as a wireless BSS (basic service set). In a present-day wireless network, key exchange delay as much as 100 milliseconds or more may be encountered when a wireless device roams to a new access point. In order to assist with providing fast, seamless roaming, it is desirable to generate and establish key exchanges substantially instantaneously, e.g., much less than forty milliseconds.

The present invention addresses the aforementioned and other problems by providing a fast key generator (FKG) and method thereof to rapidly or dynamically generate and re-generate encryption or decryption keys, e.g., either 128-bit, 256-bit, or other key length, for use in data security applications.

Techniques employed by a preferred embodiment of the present invention differ from prior systems in using a common network ID or other identifier as a root key that is shared among other devices on the network; along with other safeguarded parameters (e.g., two or more) that form part of a transformation of the root key to produce an encryption key. Key generation/re-generation time is fully deterministic within a bounded time period.

### SUMMARY OF THE INVENTION

A first embodiment of the invention comprises an encryption/decryption key generator that dynamically generates a key to provide a device with secure access to a wireless network. The key generator comprises a multi-byte identifier shared by devices communicating with the network, a hashing module to transform the multi-byte identifier to a multi-bit digest thereof, a clock register that enables an output of a number of clock cycles determined by the digest, a programmable shift register that responds to the clock cycles to transform at least two safeguarded parameters to an output, and a spreader responsive to the digest and the output of the shift register to produce the encryption/decryption key.

A second embodiment of the invention comprises a key generator that generates a pseudo-random key including an identifier shared by devices communicating over a network, a hashing module to transform the identifier into a digest, a clock register that enables an output of a number of clock cycles determined by the value of the digest, a shift register that responds to the clock cycles to transform values of at least two safeguarded parameters to produce an output, and a spreader responsive to the digest and the output of the shift register to produce said pseudo random key.

A third embodiment of the invention comprises a client device that uses key generator to generate a pseudo-random key that enables communication with a network. The client device utilizes a network identifier or portion thereof, a hashing module that transforms the identifier to a digest, a clock register that produces a clock signal having a number of cycles determined by the digest, a shift register that responds to the clock cycles to transform values of at least two parameters to produce an output, and a spreader responsive to the digest and the output of the shift register to produce said pseudo random key.

In yet another embodiment, the invention comprises a method of producing an encryption/decryption key that enables a network device to securely access a network where the method comprises providing a multi-byte identifier, hashing the identifier to produce a multi-bit digest, generating a number of clock cycles defined by the multi-bit digest, transforming in a shift register at least two parameters to produce a transformed output, and converting the transformed output and control bits of the digest to an encryption/decryption key that provides secure access.

In yet a further embodiment, the invention comprises an encryption key generator comprising a multi-bit identifier, a hashing module to reduce the multi-bit identifier to a multi-bit digest, a clock register to output a number of clock cycles defined by said digest, a programmable shift register that receives at least two parameters and that responds to the clock cycles to logically operate on and shift the contents thereof, and a spreader responsive to the digest and the programmable shift register to produce an encryption/decryption key.

Preferred features include providing an identifier, or portion thereof, that is common to other devices on the network; bytewise exclusive-OR'ing respective byte pairs of the identifier to produce a digest; altering the safeguarded parameters (e.g., initial state of the shift register and/or coefficients of a polynomial) in response to detection of an unauthorized attempt to access the network; providing a plurality of demultiplexers to produce an encryption key in response to the shift register output and unique combinations of digest bits; and/or providing a software implementation one or more of the hardware or firmware elements.

Other aspects and features of the invention will become apparent upon review of the following disclosure taken in connection with the accompanying drawings. The invention, though, is pointed out with particularity by the appended claims.

### BRIEF DESCRIPTION OF THE DRAWINGS

FIG. 1 is a conceptual block diagram of a fast key generator according to one implementation of the present invention.

FIG. 2 shows one possible implementation of the hashing module depicted in FIG. 1 to transform a network ID or other identifier.

FIG. 3 shows a down counter that establishes a counter sequence provided the CLK REGISTER of FIG. 1.

FIG. 4 illustrates one implementation of the programmable or re-configurable linear feedback shift register (LFSR) depicted in FIG. 1.

FIGS. 5A and 5B respectively show 256-bit and 128-bit SPREADERS that may be used with the system of FIG. 1 to convert the LFSR output and selected bits of the HASH module in order to generate an encryption key.

### DESCRIPTION OF ILLUSTRATIVE EMBODIMENTS

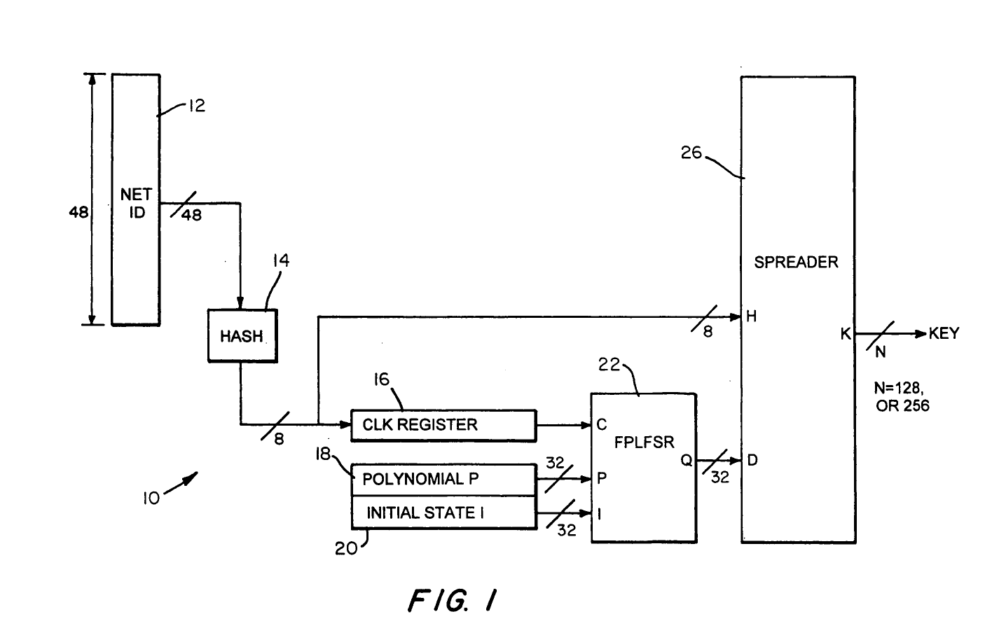

The fast key generator 10 of FIG. 1 may be implemented in software, firmware, or hardware. A firmware or hardware implementation, however, provides optimal performance. In the illustrated embodiment, key generator 10 provides roaming or other devices with network access within much less than forty milliseconds. A register or memory location 12 of key generator captures six bytes, i.e., 48-bits of network identification data, i.e., a NET ID, which may comprise the six most significant bytes MSBytes, the six least significant bytes LSBytes, or other bytes of the network ID. NET ID may also be generated from a BSS ID or other identifier. Since each device on the network will share the same 48-bit identifier, the NET ID serves as a common identifier for all devices. Despite wide knowledge of NET ID, however, rogue devices cannot compromise the encryption routine because decryption also requires knowledge of safeguarded parameters, including a POLYNOMIAL P of register 18 and/or the initial state I (20) of a linear feed shift register (LFSR) 22. These parameters are safeguarded within device(s) on which the fast key generator resides.

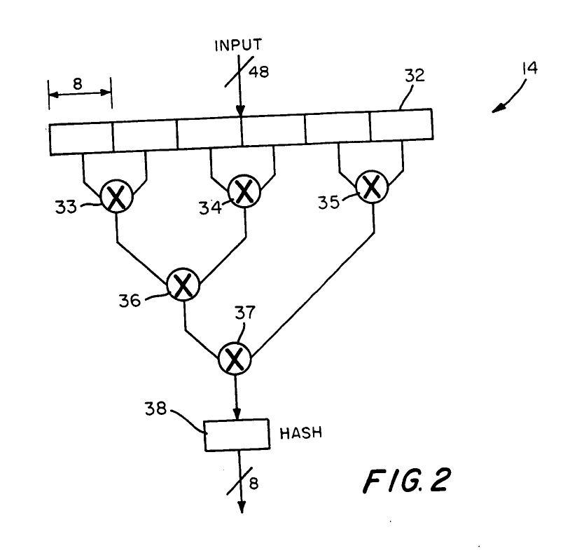

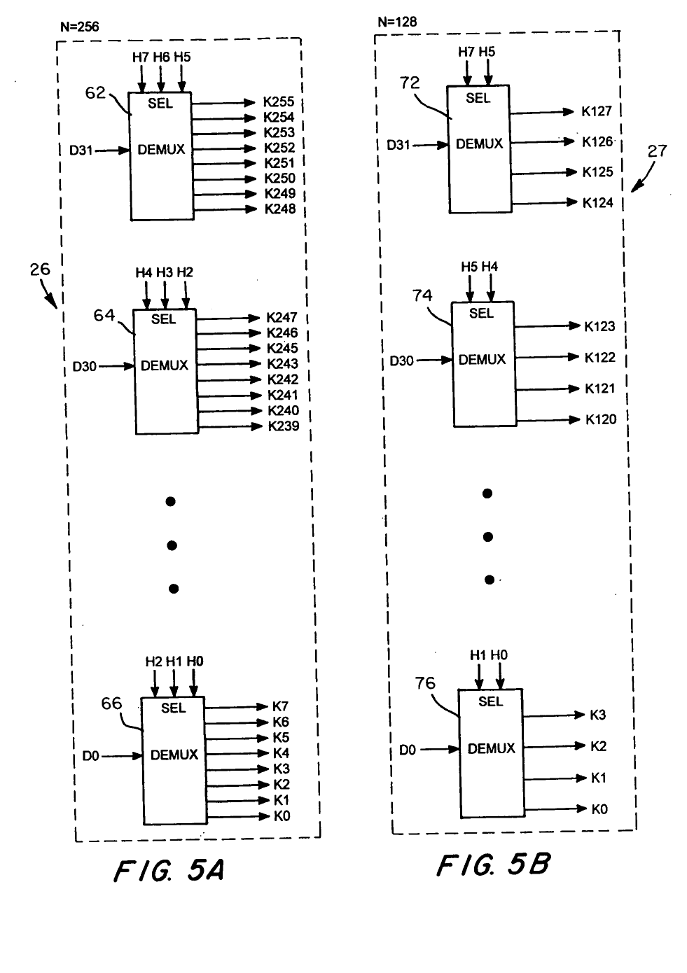

After obtaining the 48-bit NET ID from a network device or other source, HASH module 14 transforms or maps the six-byte, 48-bit identifier to an eight-bit digest or abbreviation thereof. In one embodiment, HASH module 14 comprises a cascaded set of bytewise exclusive-OR primitive or gates 33-37, as shown in FIG. 2. Exclusive-OR gates 33, 34, and 35 perform byte-wise transformations of the contents respective pairs of bytes in register 32. Thereafter, exclusive-OR gate 36 transforms the results of gates 33 and 34 while exclusive-OR gate 37 transforms the results of gates 35 and 36. The 8-bit result of gate 37 is subsequently stored in register 38, which provides a pseudo-random control value to set an initial count in CLK REGISTER 16, CLK REGISTER 16 drives or clocks FPLFSR (Full Programmable Linear Feedback Shift Register) 22 with a predetermined or metered number of clock cycles. HASH result 38 also provides a control-octet for the SPREADER 26 to output an encryption key by controlling SEL inputs of a series a demultiplexers comprising the SPREADER, as subsequently described with reference to FIGS. 5A and 5B

HASH module 14 may comprise other arrangements of primitives or gates to produce a HASH result 38, however, the bytewise exclusive-OR transformation of an identifier was found to be robust, compact, and easy to implement. In the illustrated embodiment, bytewise transformations occur within one or two clock cycles.

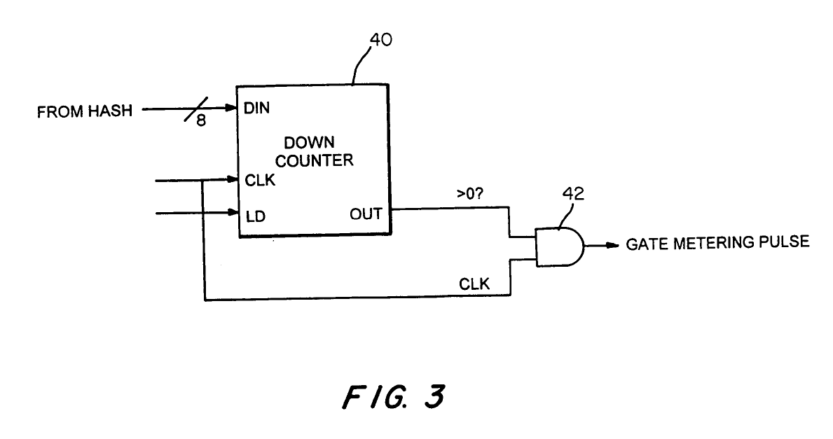

Upon initiating the fast key generator, the eight-bit HASH output 38 is loaded into CLK REGISTER 16, shown as down-counter 40 of FIG. 3. Concurrently, respective values for the “POLYNOMIAL P” (18) and the “LFSR INITIAL STATE I” (20) are loaded into the LFSR 22. Next, down-counter 40 (FIG. 3) begins to count down a number of clock cycles initially stored in CLK REGISTER 16 in response to successive clock cycles provided by a system clock. An AND gate 42 having one input coupled to the output of CLK REGISTER 16 passes clock pulses applied to the other gate as long as the value in down counter 40 remains above zero. A gated clock (i.e., a pulse train) is thus created at the output of AND gate 42. When the down counter reaches zero, AND gate 42 halts further clock pulses thereby freezing the state of shift register 22. Thus, CLK REGISTER 16 provides a predetermined number of pulses to shift register 22.

Full Programmable Linear Feedback Shift Register (LFSR) 22 is capable of implementing any 32-bit polynomial with any pre-loaded initial value. The polynomial itself may be rapidly changed during roaming, the FKG invoked, and a new key generated within the count contained in CLK REGISTER 16 plus few clock cycles; that is, one clock cycle propagation time through “NET ID” register, two clock cycles of propagation time through HASH module 14″, two clock cycles of propagation time through “SPREADER”, and the number of clock cycles specified by CLK REGISTER 16.

Because HASH module 14 supplies eight bits to CLK REGISTER 16, i.e., 255 cycles, the upper bound of the time to generate a key is about two hundred and sixty clock cycles including a few cycles to load and unload a count value in CLK REGISTER 16. Using an 80-MHz system clock (12.5 ns period), the illustrative fast key generator produces a 128-bit or a 256-bit encryption key within 3.25, microseconds thus providing a substantial improvement in response time over prior systems and methods. Other key lengths and system clock speeds may also be employed.

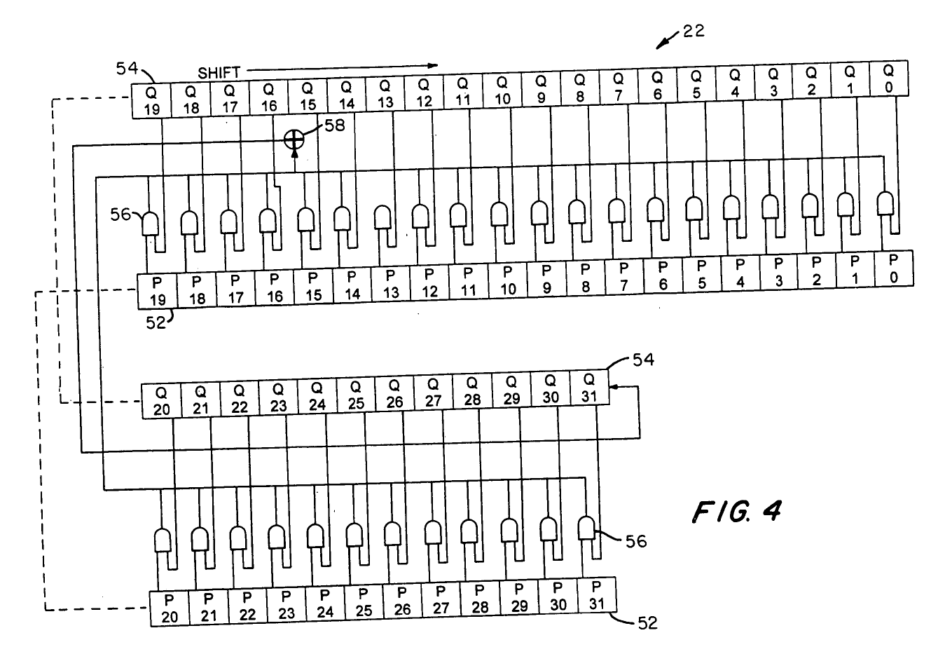

To further transform the 8-bit digest of HASH register 38, a 32-bit polynomial is loaded into cells P31-P0 of holding register 52. Coefficients of the polynomial that contribute to defining the unique encryption key may be user-defined, selected among a group of unique polynomials, defined in relation to system parameters, or determined by other means that establish uniqueness. An initial state I (for example, all 1's) is loaded into cells Q31-Q0 of shift register 54. As shown in FIG. 4, gate 58 exclusive-OR's a concatenation of each term in the polynomial (i.e., the terms of cells P31 -P0) ANDed with each term in the shift register 54. The output of exclusive-OR gate 58 is then shifted into the most significant bit of register 54 (i.e., cell Q31). Both the initial state I and the coefficients of polynomial P are dynamically configurable to provide rapid configuration and reconfiguration of the fast key generator. The 32-bit output of register 54, i.e., cells Q31 through Q0, as well as the output of eight-bit HASH module 14 , is then transmitted to the SPREADER.

FIGS. 5A and 5B show exemplary SPREADERS 26 and 27 that generate encryption/decryption keys having a key length N of 256-bits and 128-bits, respectively. In the illustrated embodiment, demultiplexers are used to implement the SPREADERS where ordering and values of the HASH digest determine bit values of the encryption key produced at the output stage thereof.

SPREADER 26 of FIG. 5A, coupled with the 8-bit output of HASH module 14, translates the 32-bit output of register 54 to a 256-bit encryption key. In this configuration, thirty-two eight-bit conventional demultiplexers (demultiplexers 66, 64, and 62 are shown) generate the 256-bit key. Respective bits of the HASH digest 38 (FIG. 2) respectively applied to the SEL inputs of the demultiplexers control the demultiplexers in a conventional way to convert the thirty-two bit data sequence applied at data inputs D0 . . . D31 to a 256-bit encryption key K0 . . . K256 at the demultiplexer outputs. The manner of applying the HASH digest bits to the SEL inputs of the demultiplexers are listed as follows where H0 . . . H7 represent respective bits of the HASH digest:

| Input | SEL |
|---|---|
| D31 | H7 H6 H5 |
| D30 | H4 H3 H2 |
| D29 | H1 H0 H7 |
| D28 | H6 H5 H4 |
| D27 | H3 H2 H1 |
| D26 | H0 H7 H6 |
| D25 | H5 H4 H3 |
| D24 | H2 H1 H0 |
| D23 | H7 H6 H5 |
| D22 | H4 H3 H2 |
| D21 | H1 H0 H7 |
| D20 | H6 H5 H4 |
| D19 | H3 H2 H1 |
| D18 | H0 H7 H6 |
| D17 | H5 H4 H3 |
| D16 | H2 H1 H0 |
| D15 | H7 H6 H5 |
| D14 | H4 H3 H2 |
| D13 | H1 H0 H7 |
| D12 | H6 H5 H4 |
| D11 | H3 H2 H1 |
| D10 | H0 H7 H6 |
| D09 | H5 H4 H3 |
| D08 | H2 H1 H0 |
| D07 | H7 H6 H5 |
| D06 | H4 H3 H2 |
| D05 | H1 H0 H7 |
| D04 | H6 H5 H4 |
| D03 | H3 H2 H1 |
| D02 | H0 H7 H6 |
| D01 | H5 H4 H3 |
| D00 | H2 H1 H0 |

Within one or two clock cycles, the demultiplexers generate a randomized 256-bit encryption/decryption key seeded by the NET ID, POLYNOMIAL P, and the initial state I of the LFSR 22. The NET ID is public broadcast knowledge within a BSS or other network device, while the POLYNOMIAL P and the initial state I of LFSR 22 are safeguarded by the user and/or the network.

FIG. 5B shows SPREADER 27 having an arrangement of demultiplexers 72, 74, and 76 to generate a 128-bit encryption/decryption key. In this case, thirty-two four-bit demultiplexers having SEL inputs driven by two hash bits generate the 128-bit key. SEL inputs of the demultiplexers are controlled as follows where H0 . . . H7 represent respective bits of the HASH digest:

| Input | SEL |
|---|---|
| D31 | H7 H6 |
| D30 | H5 H4 |
| D29 | H3 H2 |
| D28 | H1 H0 |
| D27 | H7 H6 |
| D26 | H5 H4 |
| D25 | H3 H2 |
| D24 | H1 H0 |
| D23 | H7 H6 |
| D22 | H5 H4 |
| D21 | H3 H2 |
| D20 | H1 H0 |
| D19 | H7 H6 |
| D18 | H5 H4 |
| D17 | H3 H2 |
| D16 | H1 H0 |
| D15 | H7 H6 |
| D14 | H5 H4 |
| D13 | H3 H2 |
| D12 | H1 H0 |
| D11 | H7 H6 |
| D10 | H5 H4 |
| D09 | H3 H2 |
| D08 | H1 H0 |
| D07 | H7 H6 |
| D06 | H5 H4 |
| D05 | H3 H2 |
| D04 | H1 H0 |
| D03 | H7 H6 |
| D02 | H5 H4 |
| D01 | H3 H2 |
| D00 | H1 H0 |

The illustrated fast key generator generates a random 128-bit or 256-bit key in two hundred and sixty clock cycles or less, or in about 3.25 microseconds using an eighty-megahertz system clock. The demultiplexers may also be expanded to provide 512-bit or higher key lengths.

Instead of exclusive-OR'ing, the HASH module may implement other transformation functions without departing from the scope of the invention. Furthermore, parameters including polynomial P and/or the initial state I of LFSR may be rapidly or dynamically changed, and a new key regenerated within two hundred and sixty clock cycles. Other parameters may also be employed. Even though the NET ID is public broadcast information, parameters of the key generator may easily be changed by altering the polynomial or initial state of the LFSR upon detection of a rogue intruder thereby providing dynamic encryption keys without suffering throughput delays in a wireless or other network. This is particularly useful to provide seamless roaming, VoIP, Isochronous time-critical applications. Last, although the illustrative embodiment describes wireless communication, the invention is applicable to wired or terrestrial communication links requiring seamlessly jumping or switching between or among gateways, access points, or other network control devices within a minimal time period.

1. A key generator that dynamically generates an encryption/decryption key to provide a device with secure access to a wireless network, said key generator comprising:
a multi-byte identifier shared by devices communicating with the network,
a hashing module to transform the multi-byte identifier to a multi-bit digest thereof,
a clock register that enables passage of a number of clock cycles determined by said digest,
a programmable shift register that responds to said clock cycles to transform at least two safeguarded parameters to an output, and
a spreader responsive to the digest and the output of said shift register to produce said encryption/decryption key.

2. The key generator of claim 1 wherein said identifier comprises at least a portion of a network identifier that is common to devices communicating with the wireless network.

3. The key generator of claim 1, wherein said hashing module transforms bytes of said identifier to produce said digest.

4. The key generator of claim 3, wherein said hashing module comprises a cascaded set of exclusive-OR gates that transforms respective byte pairs of said identifier to produce said digest.

5. The key generator of claim 1, wherein said parameters comprise an initial state value and a polynomial representation that are supplied to said shift register.

6. The key generator of claim 5, wherein said shift register shifts contents thereof in response to high-speed clock signals enabled by said clock register.

7. The key generator of claim 6, wherein one of the initial value and polynomial representation changes in response to detection of an unauthorized attempt to access said network.

8. The key generator of claim 1, wherein said spreader comprises a plurality of demultiplexers that produce said encryption key in response to the shift register output and unique combinations of bits of said digest.

9. A key generator that generates a pseudo-random key, said key generator comprising:
an identifier shared by devices communicating with a network,
a hashing module to transform the identifier to a digest,
a clock register that enable passage of a number of clock cycles determined by said digest,
a shift register that responds to said clock cycles to transform values of at least two safeguarded parameters to produce an output, and
a spreader responsive to the digest and the output of said shift register to produce said pseudo random key.

10. The key generator of claim 9, wherein said digest comprises a multi-bit digital value that sets the number of initial clock cycles of said clock register and that also controls the spreader to produce the pseudo-random key.

11. The key generator of claim 9, wherein said safeguarded parameters are configurable.

12. The key generator of claim 9, wherein said hashing module comprises a cascaded set of exclusive-OR gates that act upon respective byte pairs of said digest to produce said digest.

13. The key generator of claim 9, further comprising a software routine that implements at least one of said hashing module, said shift register, and said spreader.

14. A client device that uses a key generator to generate a pseudo-random key that enables secure communication with a network, said device comprising:
a network identifier,
a hashing module that transforms the identifier to a digest,
a clock register that enable generation of a clock signal having a number of cycles determined by said digest,
a shift register that responds to the clock cycles to transform values of at least two parameters to produce an output, and
a spreader responsive to the digest and the output of said shift register to produce said pseudo random key.

15. The client device of claim 14, wherein said parameters are configurable.

16. The client device of claim 14, wherein said hashing module comprises a cascaded set of exclusive-OR gates.

17. The client device of claim 14, further including program code that implements at least one of said hashing module, said shift register, and said spreader.

18. A method of producing a key that enables a network device to securely access a network, said method comprising:
providing a multi-byte identifier,
hashing the identifier to produce a multi-bit digest,
generating a number of clock cycles according to the multi-bit digest,
transforming at least two parameters to produce a transformed output, and
converting the transformed output and control bits of said digest to a key that provides secure access.

19. The method of claim 18, wherein said hashing step comprises exclusive-OR'ing respective byte pairs of said identifier to produce said digest.

20. The method of claim 18, wherein said transforming step includes performing a logical operation on respective pairs of bit values of an initial state and coefficients of a polynomial.

21. The method of claim 20, further including dynamically altering at least one of said initial state and polynomial in response to detection of an unauthorized attempt to access said network.

22. A key generator comprising:
a multi-bit identifier,
a hashing module to reduce the multi-bit identifier to a multi-bit digest,
a clock register to enable output of a number of clock cycles defined by said digest,
a programmable shift register that receives at least two parameters and that responds to said clock cycles to logically operate on and shift the contents thereof, and
a spreader responsive to the digest and the programmable shift register to produce a key.
